(19) United States
(12) Patent Application Publication
(10) Pub. No.: US 2008/0282465 A1
(43) Pub. Date: Nov. 20, 2008

(54) SHOWER TAP WITH A STABLE ROTATIONAL SPEED

(75) Inventor: Ching-Chen SHIEH, Taichung (TW)

Correspondence Address: BROWDY AND NEIMARK, P.L.L.C.;624 NINTH STREET, NW, SUITE 300, WASHINGTON, DC, 20001-5303, US

(73) Assignee: Globe Union Industrial Corp., Taichung (TW)

(21) Appl. No.: 11/748,584

(22) Filed: May 15, 2007

(51) Int. Cl. B05B 1/18

(52) U.S. Cl. 4/615

(57) ABSTRACT

A shower tap with a stable rotational speed of present invention uses the resistance that generates by the water, which goes in and out of the receiving portion to against the blade device. So, the water pressure will not speed up the blade device and the outlet base has a stable rotational speed.

### BACKGROUND OF THE INVENTION

1. Field of the Invention

The present invention relates to sanitations, more particularly to a shower tap with a stable rotational speed,

2. Description of the Related Art

A rotational shower bath tap as disclosed in U.S. Pat. No. 6,896,201 is a tap, which has a rotational function to provide a rotational spout. In the present day, the shower tap mainly includes a main tube having a pivotal portion at one end. A rotational rod and a blade device are pivoted inside the pivotal portion. The rotational rod connects with a rotational outlet base. When the water comes into the pivotal portion and pushes the blade device to rotate, the rotational rod and the rotational outlet base move along with the blade device and achieve the rotation and spray object.

Owing to the water pressure is the mainly power of the blade device, the shower tap can provide the rotational spout and massage function by the water pressure. However, there is a disadvantage in this prior art. Owing to the water pressure pushes the rotational shower tap to rotate, the rotational speed of the shower tap will increase as the water pressure goes up. The main object of the shower tap is to provide rotational spout for massage and to relax people. But, a shower tap with high rotational speed usually give user psychological pressure and loses the main object.

### SUMMARY OF THE INVENTION

The one object of the present invention is to provide a shower tap with a stable rotational speed, which may not change the rotational speed by the water pressure and rotates in a stable speed.

Another object of the present invention is to provide a shower tap with a stable rotational speed, which can provide rotational spout and massage function.

The other object of the present invention is to provide a shower tap with a stable rotational speed, which economizes on water.

To achieve these objects of the present invention, the shower tap with a stable rotational speed including: a chamber being provided in a pivotal portion. One side of said chamber provides a guide hole thereon, which communicates with said extended portion. A packing retainer is placed inside said chamber. One end of said packing retainer provides a receiving portion. The bottom of said receiving portion provides a penetrating hole therein. There is a plurality of infusing holes disposed around the wall of said packing retainer. Said infusing holes communicate with the outside of said packing retainer and the receiving portion. A water inlet is rotatable placed inside the penetrating hole of said receiving portion. One end of said water inlet is located inside said receiving portion and a plurality of vents is disposed around said water inlet thereon. Said vents communicate with the outside and the inside of said water inlet. The other end of the water inlet connects with an outlet base. A blade device is placed inside said parking retainer and connects with one end of said water inlet. There is a spill area disposed at the downside of said blade device and communicates with vents of said water inlet. A partition is placed above said blade device and there is a plurality of the guide holes disposed on said partition around.

### BRIEF DESCRIPTION OF THE DRAWINGS

FIG. 1 is a front view of the first embodiment of the present invention;

FIG. 2 is an explosion view of the first embodiment of the present invention;

FIG. 3 is a sectional view showing the cross section along with the line 3-3 in FIG. 1.

FIG. 4 is a partial enlarge view of FIG. 3, which shows a portion of the pivotal portion.

FIG. 5 is a partial perspective view of the second embodiment of present invention.

FIG. 6 is a partial enlarge view of the second embodiment of the present invention, which shows a portion of the pivotal portion.

### DETAILED DESCRIPTION OF THE INVENTION

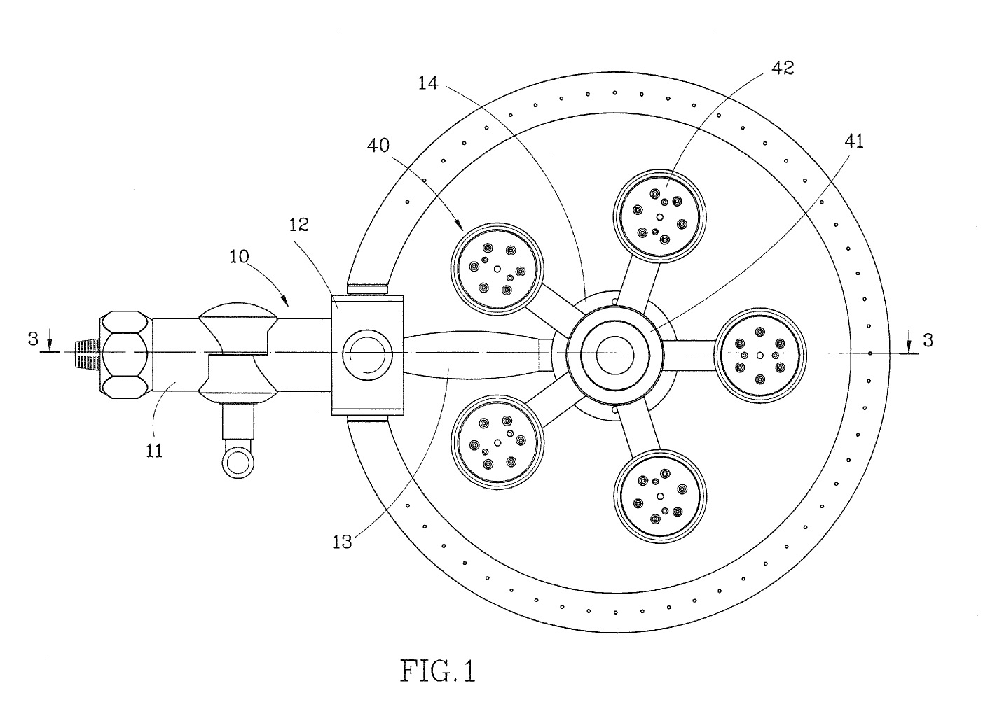

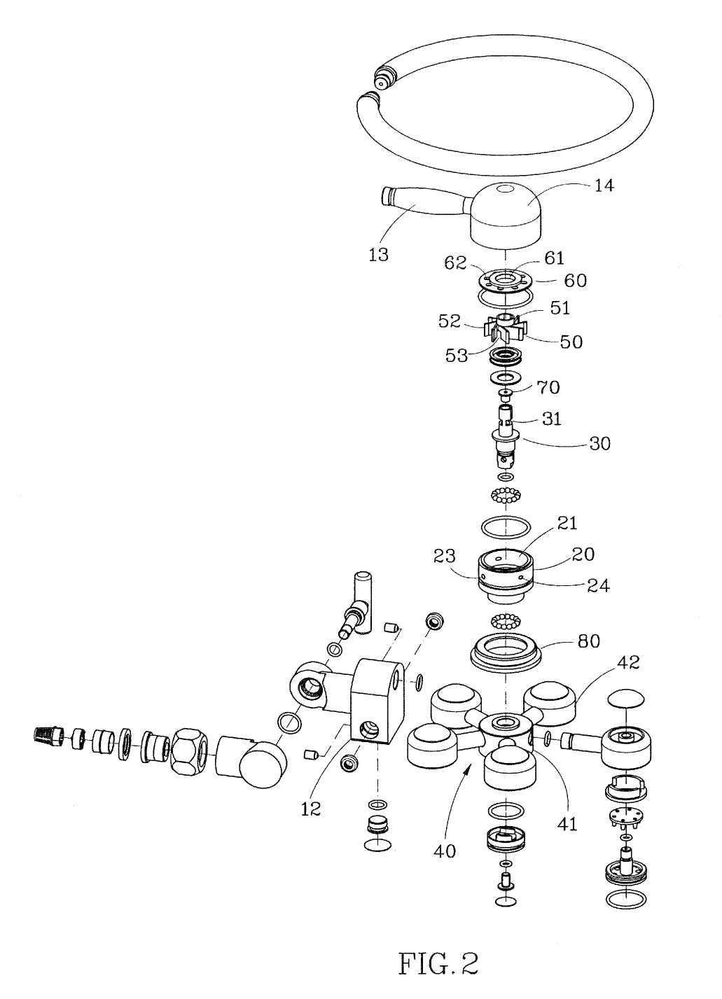

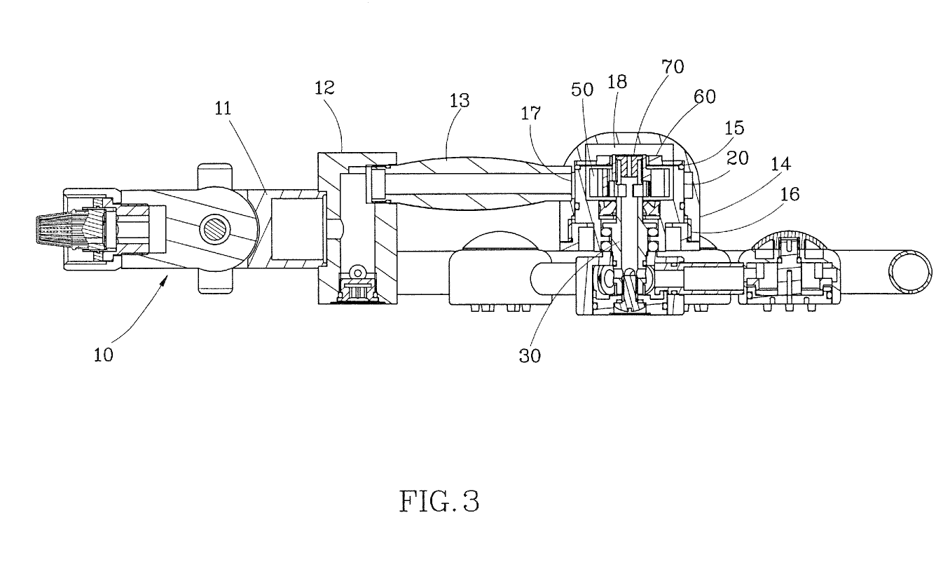

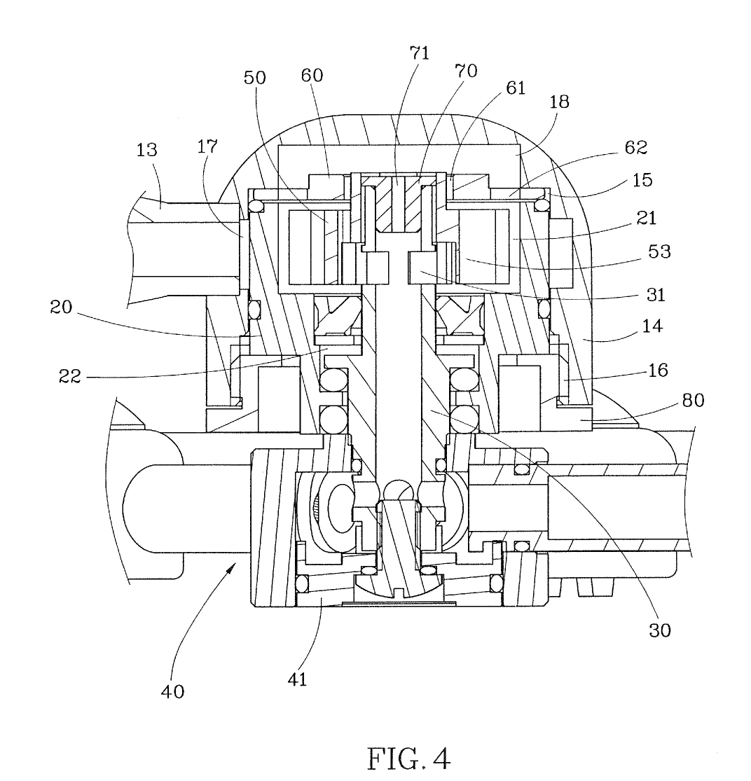

Referring to FIG. 1 to 4, the shower tap with a stable rotational speed of the first embodiment of the present invention including: a main tube 10 having an aqueduct portion 11.

A transitional portion 12 is disposed at one end of said aqueduct portion 11. An extended portion 13 connects with one end of said transitional portion. A pivotal portion 14 is provided at one end of said transitional portion 12. Said pivotal portion has a chamber 15 therein. The inside wall of said chamber 15 has thread of a screw 16 thereon. One side of said chamber 15 provides a guide hole 17 thereon, which communicates with said extended portion 13. The bottom of said chamber 15 has a pit 18 therein.

A packing retainer 20 is placed inside said chamber 15. One end of said packing retainer 20 provides a receiving portion 21. The bottom of said receiving portion 21 provides a penetrating hole 22 therein. There is a plurality of infusing holes disposed around the wall of said packing retainer 20. Said infusing holes include low infusing holes 23 and high infusing holes 24 in this embodiment. The height of said low infusing holes 23 and said high infusing holes 24 are different. Said infusing holes communicate with the outside of said packing retainer 20 and the receiving portion 21.

A water inlet 30 with a hollow tube body is rotatable placed inside the penetrating hole 22 of said receiving portion 21. One end of said water inlet 30 is located inside said receiving portion 21 and a plurality of vents 31 is disposed around said water inlet 30 thereon. Said vents communicate with the outside and the inside of said water inlet.

An outlet base 40 that rotates with said water inlet connects on the other end of said water inlet 30. Multiple water outlets are provided on said outlet base 40 for the water to drain out. Said water outlets can be divided into a main water outlet area 41 and a secondary water outlet area 42 placing around said main water outlet area in this embodiment.

A blade device 50 is constituted by an axis 51 and a plurality of blades 52. Said blade device is placed inside said parking retainer 20 and connects with one end of said water inlet 30. There is a spill area 53 disposed at the downside of said blade device 50 and communicates with the vents of said water inlet 30. Some of the blades provide a gap to constitute said spill area in this embodiment.

A partition 60 is placed above said blade device 50 and separates said chamber 15 and said pit 18. Said partition 60 has a hole 61 at the center for the water inlet 30 to pass through. There is a plurality of guide holes 62 disposed on said partition 60 around said hole 61.

A plug 70 is plugged at one end of said water inlet 30 and locates inside said chamber 15. Said plug 70 has a passing hole 71, which communicates with the outside of said plug 70 and the inside of said water inlet 30.

Said parking retainer 20, said blade device 50 and said partition 60 are covered inside said chamber 15 by a nut screwing on the thread of a screw 16 of said pivotal portion 14. According to the structures disclosed in the first embodiment, the water passes the aqueduct portion 11, the transitional portion 12 and the extended portion 13 of said main tube 10 and gets into the chamber 15 of said pivotal portion 14 under the normal water pressure. Then, the water goes through the low infusing holes 23 and the high infusing holes 24 disposed around the wall of said packing retainer 20 thereon and enters the receiving portion 21 of said parking retainer.

When the water enters the parking retainer 20, the water pushes said blade device 50 to rotate. By the way, said water inlet 30 and said outlet base 40 rotate too. Then, the water will pass the spill area 53 of said blade device 50 and the vents 31 of said water inlet 30 and enters said water inlet 30. After that, the water flows into said outlet base 40 and drains out from said water outlets. The water will go in and out of said receiving portion 21 smoothly under the normal water pressure. So, said blade device 50 rotates smoothly too.

When the water pressure goes up, the water passes the extended portion 13 of said main tube 10 and goes through the low infusing holes 23 and the high infusing holes 24 disposed around the wall of said packing retainer 20 thereon. Then, the water enters said receiving portion 21 and pushes the blades 52 of said blade device 50 to rotate. However, the water will accumulate inside said receiving portion 21 owing to the high water pressure. Then, the water will be pushed to pass the guide holes 62 on said partition 60 and enters said pit 18. But, owing to the pit has no other way out, some water inside said pit 18 goes through the passing hole 71 of said plug 70 and flows into said water inlet 30. Most of the water inside said pit 18 passes said guide holes 62 again and comes back to said receiving portion 21. Then, the water flowing from top to bottom generates a resistance to against the rotation of the blade device 50. Thus, the high water pressure will not speed up said blade device and said outlet base 40 has a stable rotational speed.

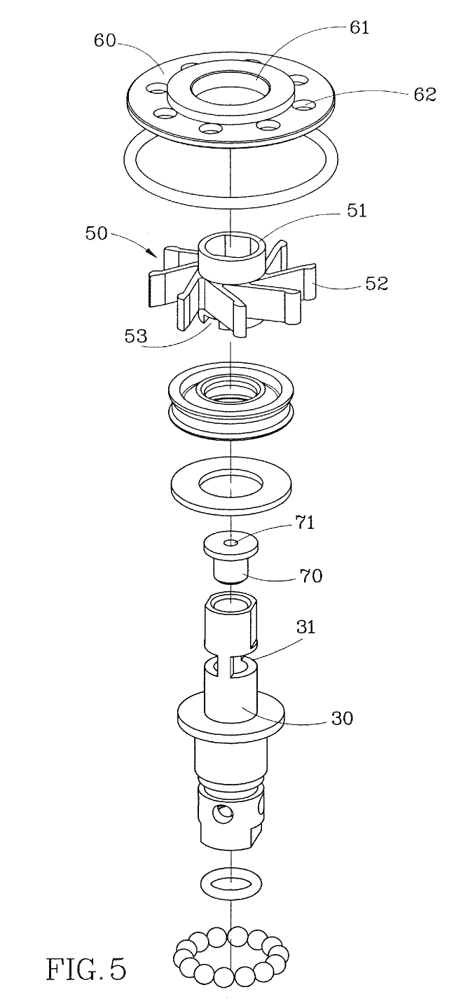

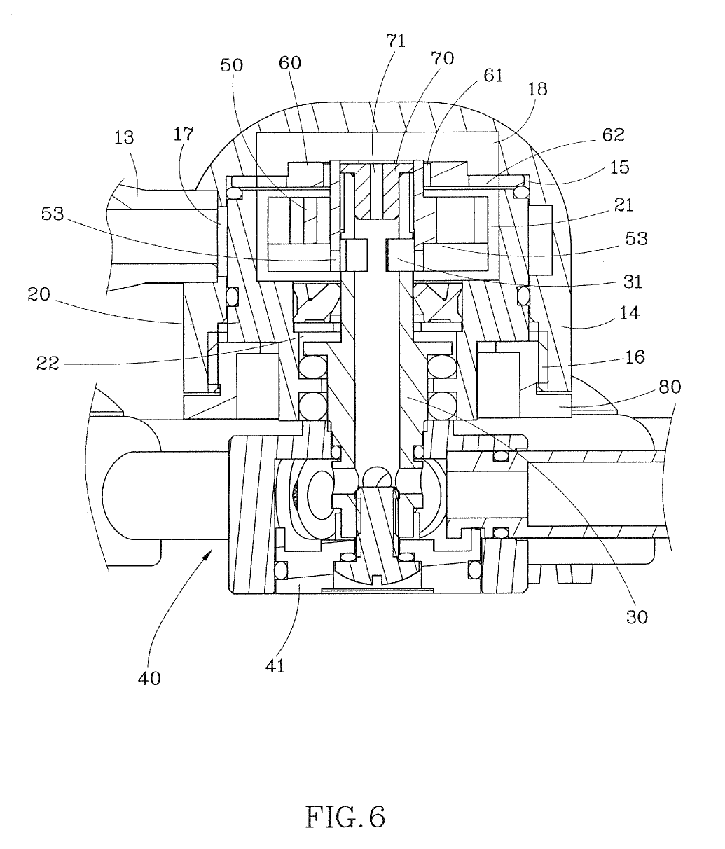

Referring to FIG. 5 and FIG. 6, it shows the second embodiment of present invention. The main structures are almost the same as aforesaid embodiment.

But, there is no gap provided on the downside of said blades in the second embodiment. The gaps are provided on the downside of said axis as a spill area in this embodiment.

According to the structures disclosed in the second embodiment, the water passes the extended portion 13 of said main tube 10 and goes through the low infusing holes 23 and the high infusing holes 24 disposed around the wall of said packing retainer 20 thereon in the normal water pressure. Then, the water enters said receiving portion 21 and pushes the blades 52 of said blade device 50 to rotate. By the way, said water inlet 30 and said outlet base 40 rotate too. Then, the water will pass the spill area 53 of said blade device 50 and the vents 31 of said water inlet 30 and enters said water inlet 30. After that, the water flows into said outlet base 40 and drains out from said water outlets.

When the water pressure goes up, the water inside said receiving portion 21 will be pushed to pass said guide holes 62 and enters said pit 18 too. The water inside said pit 18 passes said guide holes 62 again and comes back to said receiving portion 21. The water flowing from top to bottom generates a resistance to against the rotation of the blade device 50. Thus, the high water pressure will not speed up said blade device and said outlet base 40 has a stable rotational speed.

Those structures disclosed in the embodiments of the present invention not only can apply on the hanging shower tap but also the hand-held shower tap certainly. Both these applications can reach the same functions and objects.

What is claimed is:

1. A shower tap with a stable rotational speed, including:
a main tube having a pivotal portion at one end; said pivotal portion having a chamber therein and one side of said chamber providing a guide hole thereon, which communicates with said main tube;
a packing retainer being placed inside said chamber and one end of said packing retainer providing a receiving portion; the bottom of said receiving portion providing a penetrating hole therein; a plurality of infusing holes being disposed around the wall of said packing retainer thereon and said infusing holes communicating with the outside of said packing retainer and the receiving portion;
a water inlet rotatable placing inside the penetrating hole of said receiving portion and one end of said water inlet locating inside said receiving portion and a plurality of vents being disposed around said water inlet thereon; said vents communicating with the outside and the inside of said water inlet;
an outlet base that rotates along with said water inlet connecting on the other end of said water inlet; multiple water outlets being provided on said outlet base for the water to drain out;
a blade device being constituted by an axis and a plurality of blades; said blade device being placed inside said parking retainer and connecting with one end of said water inlet; a spill area being disposed at the downside of said blade device and communicating with the vents of said water inlet;
a partition being placed above said blade device and said partition having a plurality of guide holes disposed thereon.

2. The shower tap as claimed in claim 1, wherein the bottom of said chamber has a pit therein.

3. The shower tap as claimed in claim 2, wherein said partition is placed above said blade device and separates said chamber and said pit.

4. The shower tap as claimed in claim 1, wherein said partition has a hole at the center for the water inlet to pass through.

5. The shower tap as claimed in claim 4, wherein said guide holes are disposed around said hole.

6. The shower tap as claimed in claim 1, wherein some of the blades provide a gap to constitute the spill area.

7. The shower tap as claimed in claim 1, wherein there is a plug plugged at one end of the water inlet and locates inside the chamber.

8. The shower tap as claimed in claim 7, wherein said plug has a passing hole, which communicates with the outside of said plug and the inside of said water inlet.

9. The shower tap as claimed in claim 1, wherein there are gaps provided on the downside of said axis as a spill area.

10. The shower tap as claimed in claim 1, wherein said infusing holes include low infusing holes and high infusing holes and the height of said low infusing holes and said high infusing holes are different.

11. The shower tap as claimed in claim 1, wherein said water outlets can be divided into a main water outlet area and a secondary water outlet area placing around the main water outlet area.

12. The shower tap as claimed in claim 1, wherein said main tube has an aqueduct portion and a transitional portion is disposed at one end of said aqueduct portion, and an extended portion connects with one end of said transitional portion, and said pivotal portion is provided at one end of said transitional portion.
